(19) United States
(12) Patent Application Publication
(10) Pub. No.: US 2002/0111839 A1
(43) Pub. Date: Aug. 15, 2002

(54) Method and system for forming dynamic vendor coalitions in collaborative e-commerce

(76) Inventors: Nitin Nayak, Ossining, NY (US); Annap Derabail, Roswell, GA (US)

Correspondence Address: McGuire Woods, LLP, 1750 Tysons Boulevard, Suite 1800, Tysons Corner, McLean, VA, 22102-3915, US

(21) Appl. No.: 09/781,279

(22) Filed: Feb. 13, 2001

(51) Int. Cl. G06F 17/60

(52) U.S. Cl. 705/7; 705/16

(57) ABSTRACT

A method and system are used for the formation of dynamic alliances between vendors with complementary capabilities to jointly pursue specific market opportunities. Such alliances are created primarily for the purpose of satisfying a market opportunity and disbanded after the opportunity has been satisfied. Although most alliances will be short-term in nature, traditional long-term business relationships can also evolve in some cases.

### BACKGROUND OF THE INVENTION

1. Field of the Invention

The present invention generally relates to electronic marketplaces (e.g., e-commerce) where buyer requirements cannot be met completely by any single vendor and, more particularly, to a method and system for forming dynamic vendor coalitions to deliver the customer requirements jointly.

2. Background Description

In today's dynamic net-generation business environment, the window of opportunity is shrinking for many businesses due to the time and space compression effect of the Internet. In the face of intense competition, businesses are faced with the need to rapidly re-configure themselves over and over again as they strive to introduce new products and processes. Many businesses find that they are unable to fully respond to demands of the marketplace because of limited capabilities, limited capacity, range of products, location or other limitation. Such businesses may, however, be fully capable of responding at least partially to the demands and would like to participate in a response if they could find a suitable partner or partners.

### SUMMARY OF THE INVENTION

It is therefore an object of the present invention to provide a way for multiple businesses to effectively respond to demands of the marketplace in a way that allows businesses to remain competitive without the need to rapidly re-configure themselves..

According to the invention, there is provided an alternative to business re-configuration, namely formation of dynamic alliances. Dynamic networks of alliances (or coalitions) are formed between vendors with complementary capabilities to jointly pursue specific market opportunities. Such alliances are created primarily for the purpose of satisfying a market opportunity and disbanded after the opportunity has been satisfied. Although most alliances will be short-term in nature, traditional long-term business relationships can also evolve in some cases.

The invention is a process and a system for forming dynamic vendor coalitions from a pre-qualified set of vendors. It is assumed that the input for vendor coalition formation is a pre-qualified set of vendors generated by other matchmaking and filtering processes. Forming vendor coalitions involves multi-objective optimization, where the objectives might conflict with each other. Examples of such multiple objectives include:

1. Meeting customer requirements at lowest cost;

2. Delivering customer requirements in the shortest possible time;

3. Forming coalitions that have the highest group dynamic coefficient; and

4. Meeting customer requirements using vendors from a specific region.

This invention can be used in electronic marketplaces where buyer requirements cannot be met completely by any single vendor. In such a case a coalition of vendors can be formed to deliver the customer requirements by jointly leveraging the capabilities of individual vendors. Such requirements are common in project-oriented industries where development of engineered-to-order products and services is quite usual. Here a system integrator works with vendors specializing in various capabilities and puts together a proposal for the customer. Another potential area for use of this invention would be for new product or new service introduction (NPI) into a market, irrespective of industry. Here a company with an idea can rapidly assemble a team of specialists to convert the idea into reality. The NPI process again usually tends to be very project-oriented in nature.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating the vendor coalition formation and selection process;

FIG. 2 is a block diagram illustrating vendor coalition formation in a multi-level RFP tree;

FIG. 3 is a block diagram which shows in more detail the system-supported coalition formulation process according to the invention;

FIG. 4 is a block diagram illustrating project decomposition into subprojects at several levels;

FIG. 5 is a block diagram showing RFP transmission from a customer to vendors;

FIG. 6 is a block diagram illustrating the process of splitting a RFP into sub-RFPs;

FIG. 7 is a block diagram showing an example of primary vendor selection for sub-RFPs by Vendor (2) based on vendor responses (proposals) to sub-RFPs; and

FIG. 8 is a block diagram showing the response of Vendor (2) to the customer on behalf of coalition C2.

### DETAILED DESCRIPTION OF A PREFERRED EMBODIMENT OF THE INVENTION

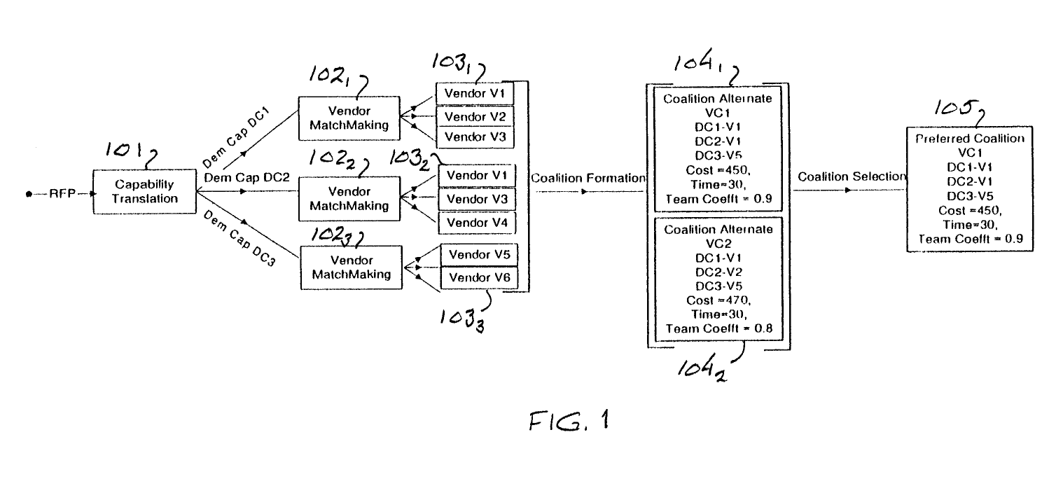

Referring now to the drawings, and more particularly to FIG. 1, there is shown an overview of the single-level, vendor coalition formation problem between a customer and several vendors. An incoming buyer request, or request for proposal (RFP), is converted into a set of demanded capabilities DC1, DC2, . . . , DCN through capability translation 101. Demanded capabilities (DC) are those that are necessary to address the requirements presented in the RFP and provided by one or more vendors. For each demanded capability, a set of potential vendors is selected through vendor matchmaking functions 102₁, 102₂, . . . , 102_{N} to whom invitations can be sent out. Thus, for example, the vendor matchmaking function 102₁ generates a set of vendors 103₁ which includes vendors V1, V2 and V3, the vendor matchmaking function 102₂ generates a set of vendors 103₂ which includes vendors V1, V3 and V4, and the vendor matchmaking function 102₃ generates a set of vendors 103₃ which includes vendors V5 and V6. The coalition formation process determines one or more coalition alternates 104₁, 104₂, etc. from which an optimal group of vendors 105 for each of the demanded capabilities is determined.

There are a few points to observe regarding this process:

1. Each demanded capability in the set DC1, DC2, . . . , DCN will have a shortlist of selected vendors who have been selected on the basis of matching their known (registered) capabilities with demanded capabilities.

2. One vendor may be able to provide more than one demanded capability as pictorially depicted in FIG. 1. Vendor V1 can provide demanded capabilities DC1 and DC 12.

Here, the formation of vendor coalitions when one vendor provides more than one demanded capability is a complex problem. In FIG. 1, two potential solutions for the coalition formation problem are:

1. Select V1 to satisfy both DC1 and DC2, and select V5 to satisfy DC3.

2. Select V1 for DC1, V2 for DC2, and V5 for DC3.

Assuming that these vendors have sufficient capacity to meet the imposed demand, both of the above solutions are feasible. However, the cost associated with them may not be the same. The total cost of solution 1 might be lower because V1 provides a lower price on the combined bid for DC1 and DC2. Also, solution 2 might be delivered quicker because three different vendors who take a smaller amount of time together to satisfy all demanded capabilities. It is immediately apparent that there a combinatorial number of feasible solutions exist for the coalition formation problem, each with an associated cost or duration to deliver. Developing an optimal solution will involve searching the entire space of solutions which can be prohibitive in terms of computation time. Therefore, implicit solution space spanning techniques are developed to solve this decision support problem.

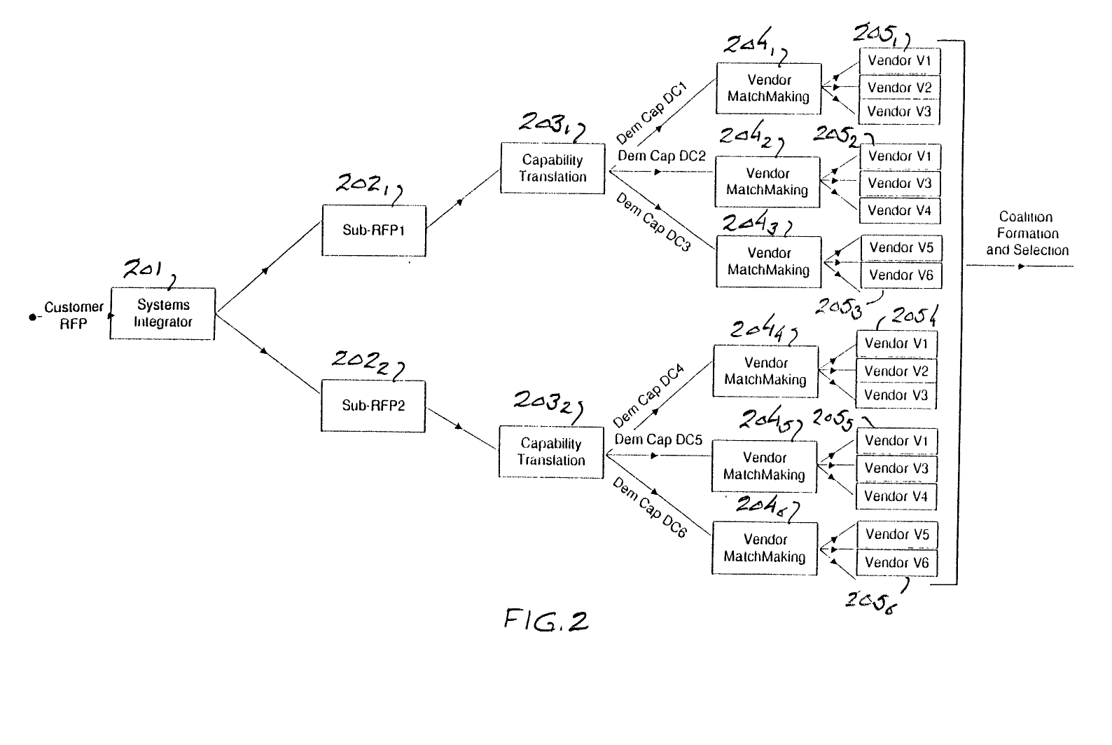

As shown in FIG. 2, when incoming RFX (i.e., request for proposal or request for quote) requirements are complex, they can be broken down into smaller sets of requirements. This task is usually performed by a systems integrator 201. The incoming RFX is split into multiple RFXs based on some criteria. The systems integrator 201 generates sub-RFXs, illustrated in FIG. 2 by way of example only as sub-RFP1 202₁ and sub-RFP2 202₂, which are then passed on to down stream capability translation, again illustrated in FIG. 2 by way of example only as capability translation 203₁ and capability translation 203₂. These translation functions produce demanded capabilities DC2, DC2, DC3 and DC4, DC5, DC6, respectively. Vendor matchmaking functions 204₁ to 204₆ then generate sets of vendors 205₁ to 205₆ which are passed to the coalition formation processes. In this situation, vendor coalitions are of a hierarchical nature depending on how many RFXs the original RFX generated. In this case, there are two categories of coalitions:

1. Single-level coalitions that are formed to meet requirements of each parent RFX node in the RFX tree. At each level in the tree, a vendor coalition can be generated that optimally meets the requirements of the parent RFX node.

2. The overall multi-level coalition for the total project (based on the incoming customer RFX) that incorporates all hierarchies. This essentially is a hierarchical aggregation of all single-level coalitions in step 1.

Multi-level coalition formation in the hierarchical situation can be based on decisions that can be either local or global in scope. When coalitions are formed based on local scope, local information within the current level in the tree is used to optimize the coalition at the current node. Results are then passed back to the parent node. Finally, the multi-level coalition that results is obtained by aggregating the results of the local coalitions at each individual node in the tree.

When vendor coalitions are formed globally, no coalition formation decisions are made at the local level. Based on the vendor selections performed during the matchmaking process, invitations are sent out. Based on the vendor responses received, global optimization may be performed by looking at the entire tree to decide how coalitions will be formed at each level in the tree rather than making decisions at individual nodes and then aggregating the results.

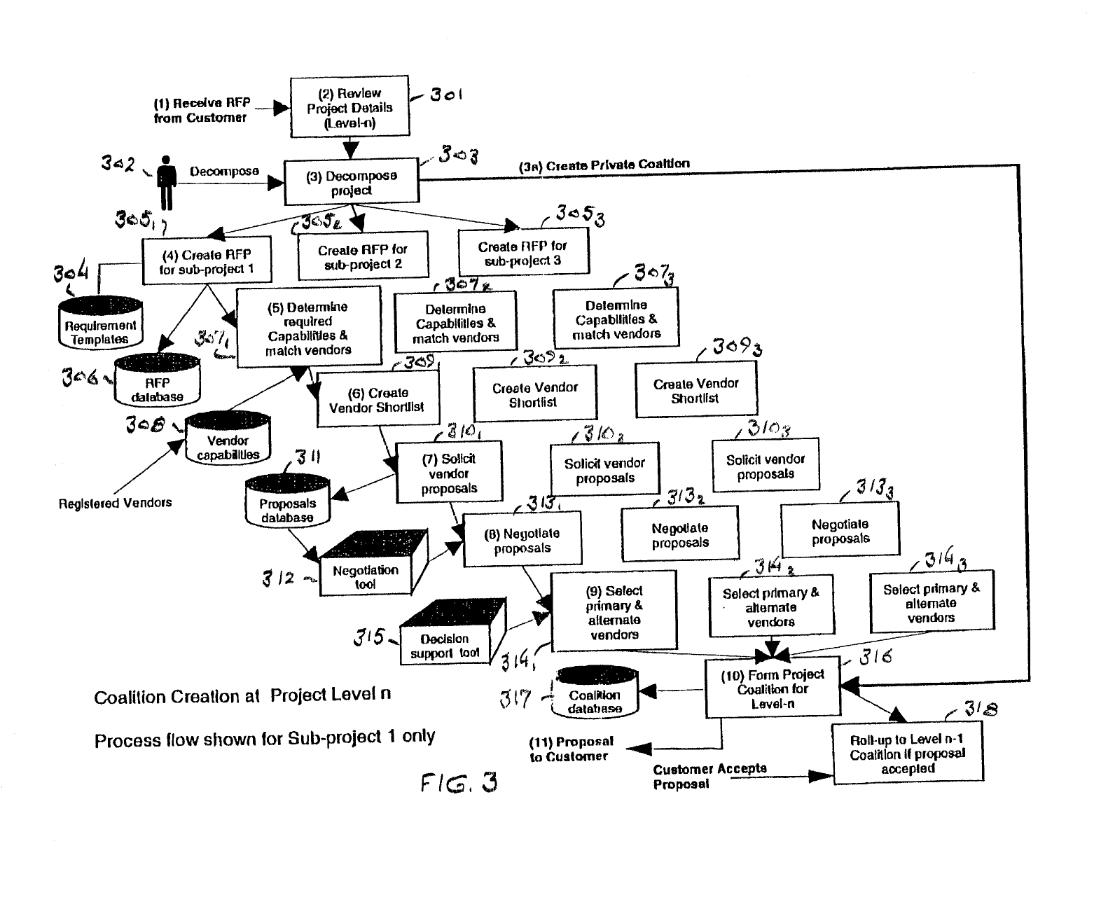

The overall coalition formation process is shown in FIG. 3. An RFP received from a customer at 301 is reviewed by the system integrator 302 at Level (n) for project details, and then the project is decomposed into sub-RFPs at 303. The system illustrated in FIG. 3 comprises several databases, templates and tools. Specifically, requirement templates 304 are used to create RFPs for sub-projects 305₁, 305₂ and 305₃. In the process of creating these RFPs, an RFP database 306 is accessed by the system, and for each RFP created, the system determines at 307₁, 307₂ and 307₃ required capabilities and matches vendors to those capabilities by accessing vendor capability database 308. After vendor short lists are prepared at 309₁, 309₂ and 309₃, vendor proposals are solicited at 310₁, 310₂ and 310₃, and the received proposals are stored in proposals database 311. The vendor proposals in database 311 are accessed by the negotiation tool 312 used by the system integrator 302 to negotiate proposals at 313₁, 313₂ and 313₃. Primary and alternate vendors are selected at 314₁, 314₂ and 314₃ using the decision support tool 315. Once the project coalition for a given coalition level is formed at 316, the coalition is stored in the coalition database 317. When the customer accepts the proposal, the system rolls up the coalition at Level (n) to the Level (n−1) coalition at 318, thereby aggregating it within the larger coalition.

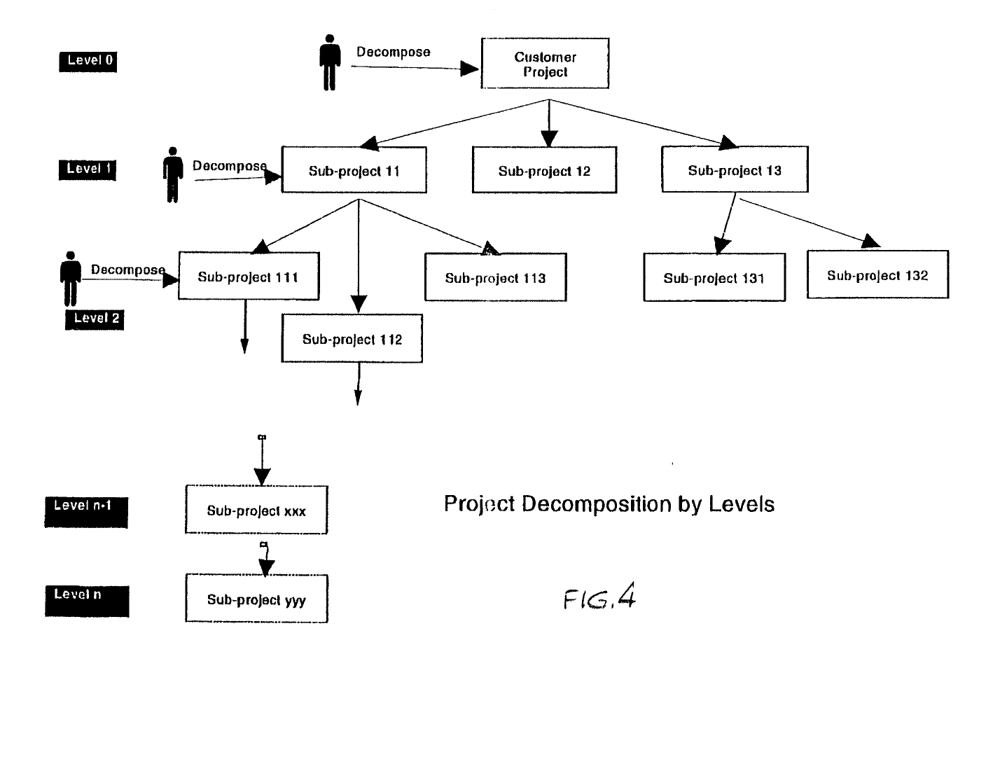

The steps illustrated by numerals within parentheses in FIG. 3 are implemented by the system. In step (1), the Vendor (n) receives an RFP from the Customer (n). In step (2), the Vendor (n) reviews the project requirements in the RFP. The Vendor (n) then decomposes the project into sub-projects in step (3), if necessary. The overall structure of project decomposition into subprojects at each layer is shown in FIG. 4.

Referring to FIG. 4, the customer project at Level (0) is decomposed into sub-projects 11, 12 and 13 at Level (1). Each of these sub-projects may be further decomposed into further sub-projects at lower levels so, for example, sub-project 11 may be decomposed into sub-projects 111, 112 and 113 and sub-project 13 may be decomposed into sub-projects 131 and 132 at Level 3.

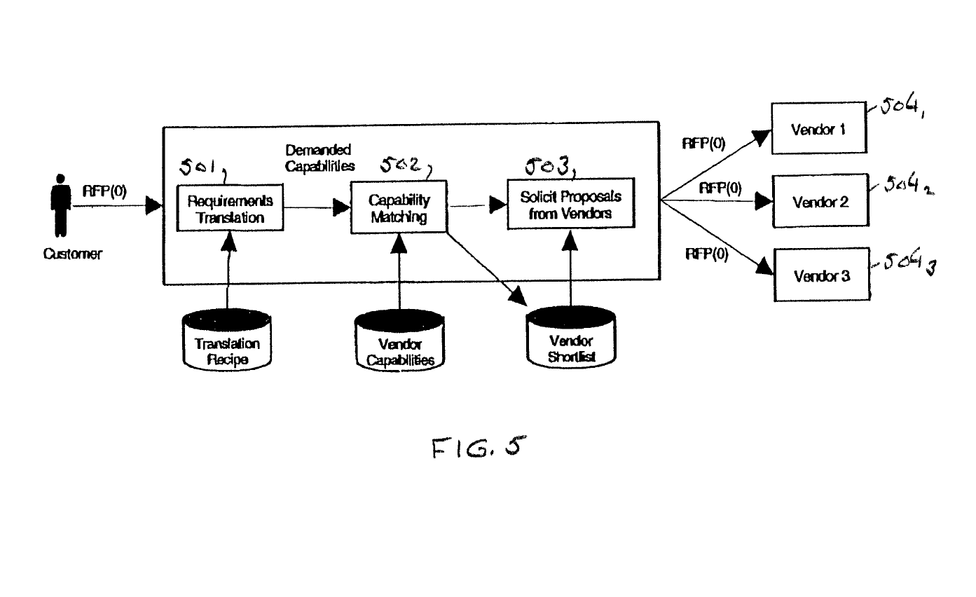

Returning now to FIG. 3, in step (4) Vendor (n) creates sub-RFPs based on the Customer (n) RFP, if necessary. Vendor (n) is now Customer (n+1) in the context of a sub-RFP. Note, if Vendor (n) has all the capabilities in-house to satisfy Customer (n) RFP, then there may be no need to create sub-RFPs. In some instances, even if Vendor (n) lacks certain capabilities, the Vendor (n) may choose to go outside the system to get services, essentially forming private coalitions in response to the Customer (n) RFP. This represented in step 3a in FIG. 3. The process of splitting RFPs into sub-RFPs is shown in FIG. 5.

In FIG. 5, the customer RFP (0) is analyzed by the data processing system to determine demanded capabilities. This processing includes requirements translation 501, capability matching 502 and soliciting proposals 503 from vendors. This last step is shown by sending the RFP (0) to a plurality of vendors 504₁, 504₂ and 504₃.

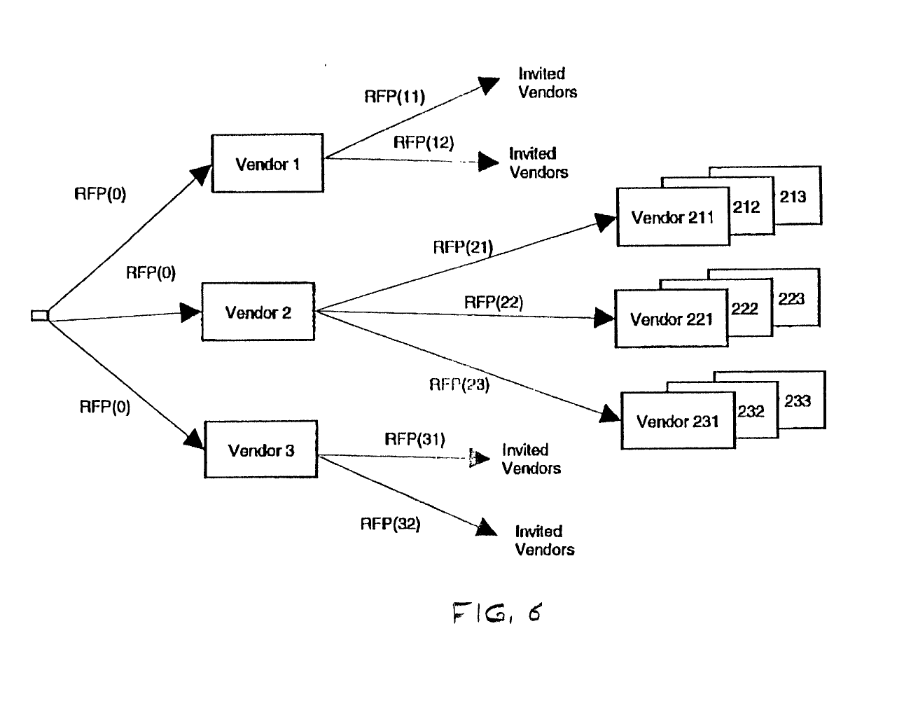

Again with reference to FIG. 3, The system determines in step (5) the capabilities required to satisfy sub-RFP requirements, if sub-RFPs are input to the system. The system matches required capabilities identified with available vendor capabilities. The system then creates in step (6) a vendor shortlist in response to a sub-RFP. The shortlist vendors are designated as belonging to Vendor (n+1) category. The system then invites vendors on the shortlist to review the sub-RFP and provide a proposal in step (7). The entire process of RFP Transmission from the customer to the invited vendors is shown in FIG. 6.

FIG. 6 shows the initial RFP (0) going to Vendor 1, Vendor 2 and Vendor 3, and each of these vendors splits the RFP (0) into two or more sub-RFPs. Taking Vendor 2 as exemplary, the RFP (0) is split into RFP (21), RFP (22) and RFP (23). Each of these sub-RFPs are submitted to one or more vendors. In the illustration, RFP (21) is submitted to Vendor 211, Vendor 212 and Vendor 213, RFP (22) is submitted to Vendor 221, Vendor 222 and Vendor 223, and RFP (23) is submitted to Vendor 231, Vendor 232 and Vendor 233.

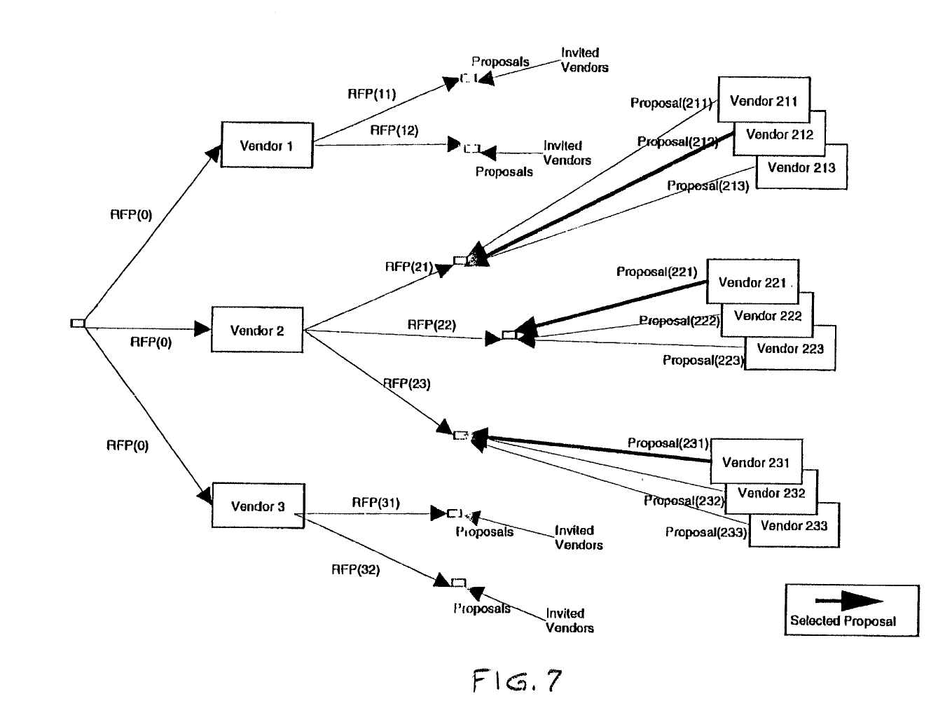

Referring back to FIG. 3, Customer (n+1) reviews Vendor (n+1) proposals in step (8). The system facilitates negotiation of the proposal between Customer (n+1) and each of Vendors (n+1). Then, in step (9), the customer selects primary and secondary Vendors (n+1) to provide the sub-RFP solutions as shown in FIG. 7.

In the example of FIG. 7, Vendor 2 selects Vendor 212 who responded to sub-RFP (21), Vendor 221 who responded to sub-RFP (22), and Vendor 231 who responded to sub-RFP (23).

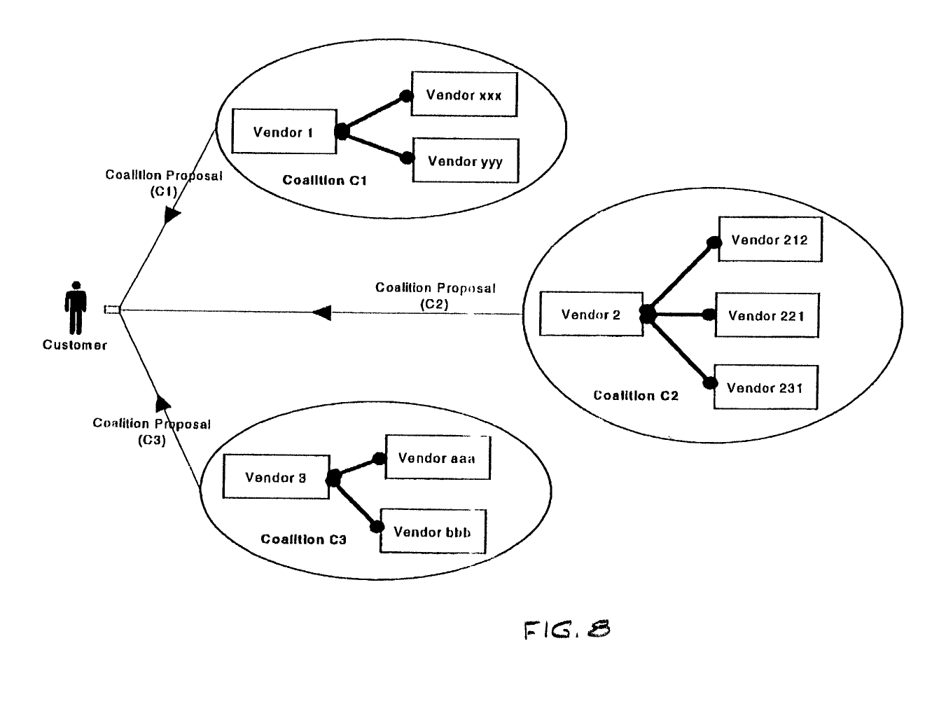

In step (10) FIG. 3, Vendor (n), who is also designated as Customer (n+1), and primary Vendor (n+1) become part of a coalition in support of Customer (n). This is a Level (n) coalition. Vendor (n+1) may have its own coalition at Level (n+1). This is rolled up into the Level (n) coalition if Vendor (n)'s proposal is accepted by the customer. If multiple sub-RFPs are created by Customer (n+1) (i.e., Vendor (n)), then several Level (n+1) coalitions may be part of the Level (n) coalition. In step (11), Vendor (n) provides a proposal to Customer (n) on behalf of the Level (n) coalition as shown in FIG. 8.

In the example shown in FIG. 8, Vendor (2) responds to the Customer on behalf of coalition C2. This coalition comprises Vendor (2) in combination with Vendor (212), Vendor (221) and Vendor (231), these latter vendors having been selected in the process illustrated in FIG. 7. Likewise, Vendor (1) responds to the Customer on behalf of coalition C1, and Vendor (3) responds to the customer in behalf of coalition C3.

It should be noted again that Vendor (n) need not create sub-RFPs and coalitions as required by the system-supported process in order to create a proposal for Customer (n). Qualified vendors could create a private coalition, as shown in step (3a) in FIG. 3, in preparation for submitting the proposal. It is also possible for Vendor (n) to provide the proposal first and then create the Level (n) coalition (either system-supported or private) to deliver the RFP solution unless, of course, the coalition's description is required as part of the proposal.

In summary, the invention facilitates a coalition formation process when a customer brings a RFP to the e-marketplace. The system gathers the requirements, analyzes the requirements to determine the capabilities required for the job, and then compares the required capabilities to a vendor capability catalog. A shortlist of potential vendors is generated, and this list may be further refined to account for customer and vendor preferences. Each vendor on the shortlist is invited to prepare a RFP response. Each vendor invited to respond in turn assesses the RFP requirements, identifies the capabilities required, and if necessary decomposes the RFP into a plurality of sub-RFPs. When the RFP is decomposed into one or more sub-RFPs by a vendor, the vendor becomes a customer, and the sub-RFPs are processed in a manner similar to that of the original RFP to generate a shortlist of potential vendors for each of the sub-RFPs. Sub-vendors with all the required capabilities can prepare proposals and the vendor, acting as a customer, can assess the proposals and select one or more sub-vendors to form a coalition. The vendor then presents a proposals to the original customer. The customer receives proposals from a plurality of vendors, who may represent one or more coalitions of vendors, and selects one or more of these to fulfill their requirements. In the context of a project, any organization can simultaneously play one or more roles; i.e., that of a customer, a vendor, or in some cases even a sub-vendor.

The process supported by the invention has the advantage of repeat business from customers because they receive services from the best team available at the time of their request. The vendors, in turn, are able to respond to customer RFPs that they might not otherwise been able to respond to.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method for the formation of dynamic alliances between vendors with complementary capabilities to jointly pursue specific market opportunities comprising the steps of:
receiving a request for proposal from a customer;
translating the request for proposal into demanded capabilities;
matching demanded capabilities with registered vendor capabilities to generate a plurality of sets of vendors which meet the demanded capabilities;
selecting one or more coalition alternates from the generated plurality sets of vendors; and
selecting a preferred coalition from the coalition alternatives to respond to the request for proposal.

2. The method for formation of dynamic alliances between vendors recited in claim 1, further comprising the step of dividing a received request for proposal into a plurality of sub-requests for proposal.

3. A coalition formation process for the dynamic alliance between multiple vendors in a marketplace comprising the steps of:
receiving a customer request for proposal;
gathering requirements needed to respond to the request for proposal;
analyzing the gathered requirements to determine capabilities required to respond to the request for proposal;
comparing required capabilities to vendor capabilities stored in a database;
generating a shortlist of potential vendors;
inviting vendors on the shortlist to prepare a response to the request for proposal;
assessing by each invited vendor the request for proposal requirements and identifying additional capabilities required;
decomposing by an invited vendor the request for proposal into a plurality of sub-request for proposals, the invited vendor becoming a customer submitting the sub-request for proposals;
gathering requirements needed to respond to the sub-request for proposals;
analyzing the gathered requirements to determine capabilities required to respond to the sub-request for proposals;
comparing required capabilities to vendor capabilities stored in a database;
generating a shortlist of potential vendors to respond to the sub-request for proposals;
inviting vendors on the shortlist to prepare a response to the sub-request for proposals;
assessing by the vendor submitting the sub-request for proposals received from vendors;
forming a coalition of vendors responding to the sub-request for proposals; and
presenting a proposal to the customer.

4. A system for the formation of dynamic alliances between vendors with complementary capabilities to jointly pursue specific market opportunities comprising:
means for receiving a request for proposal from a customer;
means for translating the request for proposal into demanded capabilities;
a database storing registered vendor capabilities;
means for accessing said database and matching demanded capabilities with registered vendor capabilities to generate a plurality of sets of vendors which meet the demanded capabilities;
means for selecting one or more coalition alternates from the generated plurality sets of vendors; and
means for selecting a preferred coalition from the coalition alternatives to respond to the request for proposal.

5. A system for representation of a coalition structure formed through a process of cascading requests for proposals across multiple tiers of vendors, the system including a database for storing vendor capabilities and means for matching demanded capabilities with vendor capabilities to select coalition members from vendors in the database and form the coalition structure, the coalition structure being a coalition of selected vendors.

6. The system recited in claim 5, further comprising means for establishing access control privileges to coalition members of the coalition structure, the access control privileges applying to sharing of common resources and services available to the coalition.

7. The system recited in claim 5, wherein the means for selecting selects members from vendors in the database and from coalitions formed by vendors in the database with other vendors not in the database.

8. The system recited in claim 5, further comprising means for providing common services to coalition members.
